(19) United States
(12) Patent Application Publication
(10) Pub. No.: US 2025/0249964 A1
(43) Pub. Date: Aug. 7, 2025

(54) Underbody Part and Method for Manufacturing Underbody Part

(71) Applicants: FUTABA INDUSTRIAL CO., LTD., Okazaki-shi (JP); Aoyama Seisakusho Co., Ltd., Niwa-gun (JP)

(72) Inventors: Yuya Miyanaga, Okazaki-shi (JP); Keiichiro Masui, Niwa-gun (JP)

(21) Appl. No.: 19/022,134

(22) Filed: Jan. 15, 2025

(30) Foreign Application Priority Data
Feb. 5, 2024 (JP) 2024-015914

(51) Int. Cl. B62D 27/06; B21D 53/88

(52) U.S. Cl. CPC B62D 27/065; B21D 53/88

(57) ABSTRACT

An underbody part is included in a vehicle underbody, comprising a mounting surface and a caulking bolt. The caulking bolt is arranged so as to protrude from the mounting surface. An end face of the caulking bolt on a base side is joined to the mounting surface by caulking.

### CROSS-REFERENCE TO RELATED APPLICATIONS

This application claims the benefit of Japanese Patent Application No. 2024-015914 filed on Feb. 5, 2024 with the Japan Patent Office, the entire disclosure of which is incorporated herein by reference.

### BACKGROUND

The present disclosure relates to an underbody part and a method for manufacturing the underbody part.

As disclosed in Japanese Unexamined Patent Application Publication No. 2022-16813, there is known a caulking bolt that is caulked to a metal member. The use of such a caulking bolt makes it possible to reduce workload required to join the same to the metal member as compared with a case in which a weld bolt is used.

### SUMMARY

However, it is necessary to provide a through hole in the metal member to use the caulking bolt disclosed in Japanese Unexamined Patent Application Publication No. 2022-16813. This is because a bearing surface of a head of the caulking bolt is caulked to the metal member while a shaft of the caulking bolt is in a state of passing through the through hole in the metal member. On the other hand, for the underbody part, which configures a lower section of a vehicle body, it is more demanded than for other miscellaneous members to strictly inhibit ingress of water for the purpose of rust prevention.

In one aspect of the present disclosure, it is desirable to inhibit ingress of water.

In one aspect of the present disclosure, the underbody part is included in a vehicle underbody and comprises a mounting surface and a caulking bolt. The caulking bolt is arranged so as to protrude from the mounting surface. An end face of the caulking bolt on a base side is joined to the mounting surface by caulking.

Such a configuration makes it possible to join the bolt to the underbody part without providing a through hole in the underbody part. It is thus possible to inhibit ingress of water.

In one aspect of the present disclosure, the mounting surface may be arranged to face an inner side of the vehicle. The caulking bolt may protrude toward the inner side of the vehicle.

Such a configuration allows an appropriate use of the bolt.

In one aspect of the present disclosure, the caulking bolt may comprise: a head having the end face and a bearing surface that faces the end face in a direction of an axis; and a shaft that is a cylindrical portion extending from the bearing surface of the head in the direction of the axis and has an outer-circumferential surface on which a screw thread is formed.

Such a configuration makes it possible to appropriately join the caulking bolt and the mounting surface of the underbody part.

In one aspect of the present disclosure, the end face of the caulking bolt may be caved in the mounting surface.

Such a configuration makes it possible to appropriately join the caulking bolt and the mounting surface of the underbody part.

In one aspect of the present disclosure, the caulking bolt may protrude upward.

Such a configuration allows an appropriate use of the bolt.

On aspect of the present disclosure relates to a method for manufacturing an underbody part that is included in a vehicle underbody. The method comprises: arranging a caulking bolt extending along an axis and a punch so as to face a mounting surface of the underbody part; arranging a die so as to face the punch with the underbody part interposed therebetween; and caulking an end face of the caulking bolt and the mounting surface together by displacing the punch to thereby press the end face toward the mounting surface, the end face being located at an end of the caulking bolt in a direction of the axis and provided with a caulking portion. The caulking bolt includes a shaft extending along the axis. The punch has a rod-like shape elongated along an extending direction and has a cavity extending along the extending direction from a leading end face located at an end of the punch in the extending direction. When the caulking is performed, the punch is displaced while the shaft is housed in the cavity of the punch.

Such a configuration makes it possible to join the bolt to the underbody part without providing a through hole in the underbody part. It is thus possible to inhibit ingress of water.

In one aspect of the present disclosure, when the caulking bolt and the punch are arranged so as to face the mounting surface, the caulking bolt and the punch may be in an accommodated state inside a tubular-shaped pad. When the caulking is performed, the punch while being displaced may be guided by the pad.

Such a configuration makes it possible to appropriately join the caulking bolt and the mounting surface of the underbody part.

In one aspect of the present disclosure, when the caulking is performed, the end face of the caulking bolt may be caved in the mounting surface.

Such a configuration makes it possible to appropriately join the caulking bolt and the mounting surface of the underbody part.

In one aspect of the present disclosure, the caulking bolt may comprise a head having the end face and a bearing surface that faces the end face in a direction of the axis. The shaft may be a cylindrical portion extending from the bearing surface of the head in the direction of the axis. When the caulking is performed, the head of the caulking bolt may be sandwiched between the leading end face of the punch, on which a cavity is provided, and a die.

Such a configuration makes it possible to appropriately join the caulking bolt and the mounting surface of the underbody part.

### BRIEF DESCRIPTION OF THE DRAWINGS

An example embodiment of the present disclosure will be described hereinafter by way of example with reference to the accompanying drawings, in which:

FIG. 1 is an explanatory diagram of a vehicle body;

FIG. 2 is an explanatory diagram of a caulking bolt;

FIG. 3 is an explanatory diagram of the caulking bolt that is caulked to an underbody part; and

FIG. 4 is an explanatory diagram showing the caulking bolt being joined to the underbody part.

### DETAILED DESCRIPTION OF EXEMPLARY EMBODIMENTS

### 1. Underbody

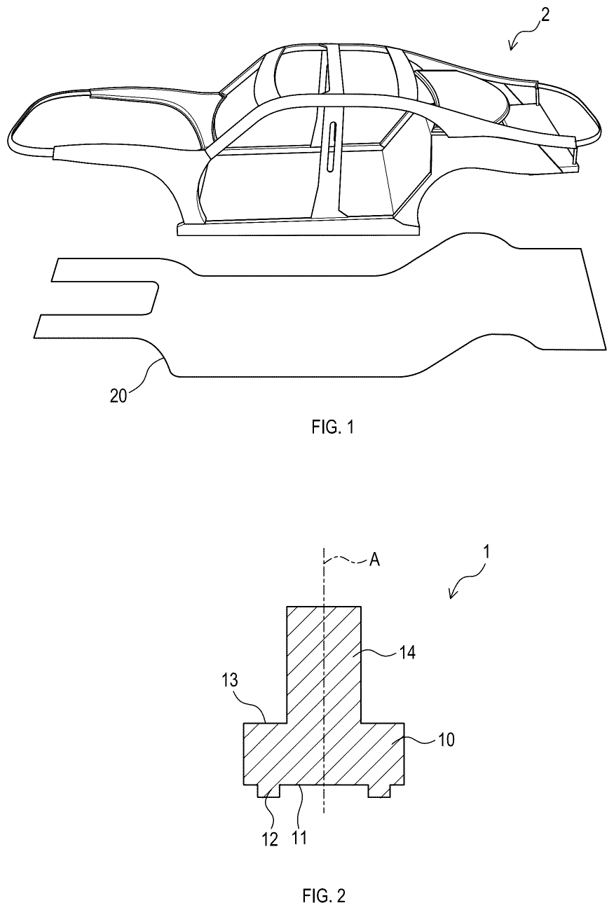

A part positioned in bottom of a vehicle body 2 is referred to as an underbody 20 (see FIG. 1). Hereinafter, one part included in the underbody 20 will be referred to as an underbody part 21. The underbody part 21 may be, for example: a component included in a vehicle cabin floor or a trunk room floor; a component provided in a lower area of an engine compartment; or a component included in a side sill located under a vehicle door. In the present embodiment, at least one caulking bolt 1 (see FIG. 2) is joined to the underbody part 21.

### 2. Caulking Bolt

The caulking bolt 1 extends along a direction of axis A and comprises: a head 10; and a shaft 14 (see FIG. 2).

The head 10 is situated at an end of the caulking bolt 1 in the direction of the axis A. There are an end face 11 and a bearing surface 13 formed in the head 10, which face each other in the direction of the axis A of the caulking bolt 1. Specifically, the end face 11 is situated opposite the bearing surface 13 in the head 10. Shapes of the end face 11 and the bearing surface 13, in other words, a shape of the head 10 as viewed in the direction of the axis A may be determined appropriately and may be, for example, circle or polygon.

The shaft 14 is a cylindrical portion that protrudes from the bearing surface 13 of the head 10 in the direction of the axis A and extends along the direction of the axis A. A screw thread is formed on an outer-circumferential surface of the shaft 14, and a tip of the shaft 14 located opposite the head 10 is inserted into a nut or a tapped hole.

A caulking portion 12 is formed, at the end face 11 of the head 10, via which the end face 11 of the head 10 and a miscellaneous member are caulked together. The end face 11 of the head 10 may be caved in the caulked miscellaneous member.

### 3. Underbody Part

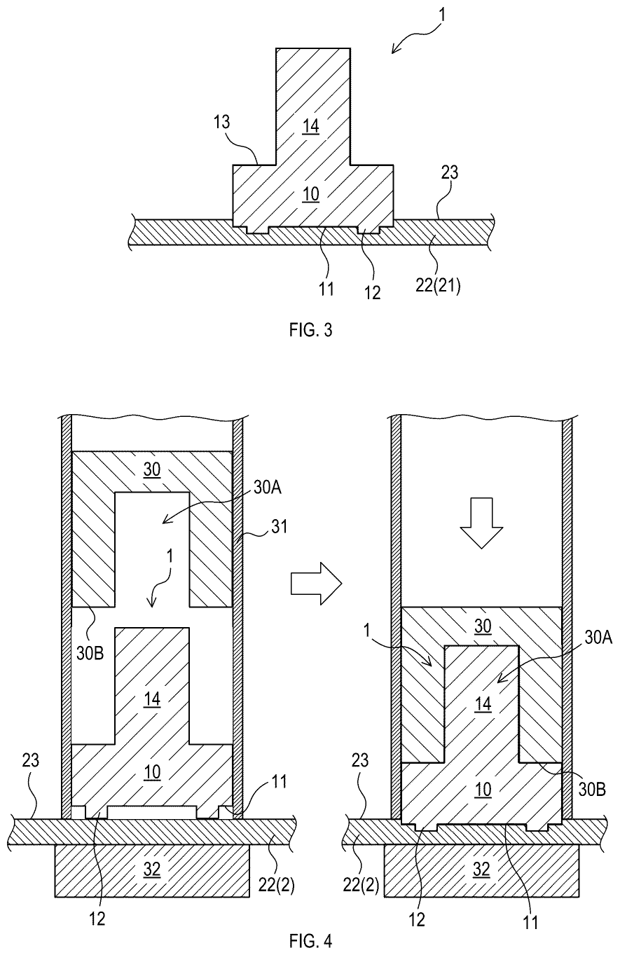

The underbody part 21 in the present embodiment includes a mounting surface 23 at a plate-shaped joining portion 22. The end face 11 of the caulking bolt 1 is caulked to the mounting surface 23 (see FIG. 3). The joining portion 22 can take various shapes besides the plate-like shape. The mounting surface 23 of the underbody part 21 faces an inner side of the vehicle, specifically, for example: the vehicle cabin, the trunk room, or the engine compartment.

Specifically, the caulking bolt 1 protrudes from the mounting surface 23 such that a tip of the caulking bolt 1 faces toward the inner side of the vehicle. The end face 11 of the caulking bolt 1 on a base side is caulked to the mounting surface 23. In one example, the caulking bolt 1 may protrude upward from the mounting surface 23.

The caulking bolt 1 provided to the mounting surface 23 may be used, for example, to hold a component installed in a vehicle. Specifically, the caulking bolt 1 may be used to hold a relatively light-weighted component, such as a cable.

### 4. Caulking

Hereinafter, descriptions will be given of an example of steps for caulking the end face 11 of the caulking bolt 1 and the mounting surface 23 of the underbody part 21. By undergoing the steps described herein, the underbody part 21 having the caulking bolt 1 arranged thereto is manufactured. When such parts are caulked, in one example, a punch 30, a pad 31, and a die 32 are used (see FIG. 4).

The punch 30 has a rod-like shape elongated along an extending direction (in one example, in a column shape) and has a cavity 30A to house the shaft 14 of the caulking bolt 1. The cavity 30A extends along the extending direction of the punch 30 from a leading end face 30B located at an end of the punch 30 in the extending direction. In one example, the leading end face 30B is located on a lower side of the punch 30, and the cavity 30A extends upward from the leading end face 30B.

The pad 31 has a tubular shape (in one example, in a cylindrical shape) and is capable of accommodating the punch 30 and the caulking bolt 1 therein. The pad 31 is configured to guide the accommodated punch 30.

First, the caulking bolt 1, the punch 30, and the pad 31 are arranged above the mounting surface 23 so as to face the mounting surface 23 of the joining portion 22 of the underbody part 21. Meanwhile, the die 32 is arranged beneath the joining portion 22 so as to face the punch 30 and the pad 31 with the joining portion 22 interposed therebetween.

At this time, a surface of the joining portion 22 opposite the mounting surface 23 is in contact with the die 32.

Moreover, the caulking portion 12 of the end face 11 of the caulking bolt 1 is in contact with the mounting surface 23, and the caulking bolt 1 extends upward from the mounting surface 23. The pad 31 is also arranged so as to extend upward from the mounting surface 23, and the caulking bolt 1 is accommodated inside the pad 31. The punch 30 is also accommodated inside the pad 31 in a displaceable manner along an up-down direction. The punch 30 is located above the caulking bolt 1, and the cavity 30A faces the caulking bolt

Then the punch 30 is displaced downward to thereby press the end face 11 of the caulking bolt 1 toward the mounting surface 23. At the same time, the shaft 14 of the caulking bolt 1 is housed in the cavity 30A, and the punch 30 is guided by the pad 31. Furthermore, the head 10 of the caulking bolt 1 is sandwiched between the leading end face 30B of the punch 30, on which the cavity 30A is formed, and the die 32. In this way, the caulking portion 12 of the end face 11 and the mounting surface 23 experience plastic deformation, causing the end face 11 and the caulking portion 12 to be caved in the mounting surface 23. The caulking portion 12 and the mounting surface 23 are thus caulked together.

### 5. Effects

(1) In the above-described embodiment, the end face 11 of the caulking bolt 1 on the base side is caulked to the mounting surface 23 of the joining portion 22 of the underbody part 21. Such a configuration makes it possible to join the caulking bolt 1 to the underbody part 21 without providing a through hole in the underbody part 21. Thus, it is possible to more reliably inhibit ingress of water from the underbody 20 into the vehicle, resulting in inhibition of rusting of the underbody 20.

(2) It is possible, with use of the caulking bolt 1 according to the aforementioned embodiment, to save labor in performing welding and in forming a through hole in the underbody part 21. It is further possible to join the caulking bolt 1 to the underbody part 21 in the step for forming the underbody part 21 by press molding. Thus, it is possible to reduce workload in the manufacture of these parts and to reduce manufacturing costs.

(3) The caulking bolt 1 is provided to the mounting surface 23 so as to protrude toward the inner side of the vehicle. This allows an appropriate use of the caulking bolt 1.

### 6. Other Embodiments

(1) In the caulking bolt 1 according to the aforementioned embodiment, the head 10 is provided with the caulking portion 12 at the end face 11. However, the caulking bolt 1 may be configured without having the head 10 and may be formed of the shaft 14. In the caulking bolt 1 configured as such, the caulking portion 12 may be provided at an end face of the shaft 14 located at its one end in the direction of the axis A. Even in such a case, it is possible to achieve the same effects by caulking the end face of the shaft 14 to the mounting surface 23 of the underbody part 21.

(2) Two or more functions achieved by one element in the aforementioned embodiment may be achieved by two or more elements; and one function achieved by one element may be achieved by two or more elements. Two or more functions achieved by two or more elements in the aforementioned embodiment may be achieved by one element; one function achieved by two or more elements may be achieved by one element. A part of the configuration of the aforementioned embodiment may be omitted. At least a part of the configuration of the aforementioned embodiment may be added to or redisposed with other configurations of the aforementioned embodiment.

What is claimed is:

1. An underbody part that is included in a vehicle underbody, the underbody part comprising:
a mounting surface; and
a caulking bolt arranged so as to protrude from the mounting surface,
wherein an end face of the caulking bolt on a base side is joined to the mounting surface by caulking.

2. The underbody part according to claim 1,
wherein the mounting surface is arranged to face an inner side of the vehicle, and
wherein the caulking bolt protrudes toward the inner side of the vehicle.

3. The underbody part according to claim 1,
wherein the caulking bolt comprises:
a head having the end face and a bearing surface that faces the end face in a direction of an axis; and
a shaft that is a cylindrical portion extending from the bearing surface of the head in the direction of the axis and has an outer-circumferential surface on which a screw thread is formed.

4. The underbody part according to claim 1,
wherein the end face of the caulking bolt is caved in the mounting surface.

5. The underbody part according to claim 1,
wherein the caulking bolt protrudes upward.

6. A method for manufacturing an underbody part that is included in a vehicle underbody, the method comprises:
arranging a caulking bolt extending along an axis and a punch so as to face a mounting surface of the underbody part;
arranging a die so as to face the punch with the underbody part interposed therebetween; and
caulking an end face of the caulking bolt and the mounting surface together by displacing the punch to thereby press the end face toward the mounting surface, the end face being located at an end of the caulking bolt in a direction of the axis and provided with a caulking portion,
wherein the caulking bolt includes a shaft extending along the axis,
wherein the punch has a rod-like shape elongated along an extending direction and has a cavity extending along the extending direction from a leading end face located at an end of the punch in the extending direction, and
wherein, when the caulking is performed, the punch is displaced while the shaft is housed in the cavity of the punch.

7. The method for manufacturing an underbody part according to claim 6,
wherein, when the caulking bolt and the punch are arranged so as to face the mounting surface, the caulking bolt and the punch are in an accommodated state inside a tubular-shaped pad, and
wherein, when the caulking is performed, the punch while being displaced is guided by the pad.

8. The method for manufacturing an underbody part according to claim 6,
wherein, when the caulking is performed, the end face of the caulking bolt is caved in the mounting surface.

9. The method for manufacturing an underbody part according to claim 6,
wherein the caulking bolt comprises:
a head having the end face and a bearing surface that faces the end face in the direction of the axis; and
a shaft that is a cylindrical portion extending from the bearing surface of the head in the direction of the axis, and
wherein the caulking is performed, the head of the caulking bolt is sandwiched between the leading end face of the punch, on which the cavity is provided, and the die.
